(19) United States
(12) Patent Application Publication
(10) Pub. No.: US 2016/0019656 A1
(43) Pub. Date: Jan. 21, 2016

(54) CLASSIFY MOBILE PAYMENT AS RECORDS

(71) Applicant: International Business Machines Corporation, Armonk, NY (US)

(72) Inventor: Lijing E. Lin, Irvine, CA (US)

(21) Appl. No.: 14/331,540

(22) Filed: Jul. 15, 2014

(51) Int. Cl. G06Q 40/00; G06Q 20/32

(52) U.S. Cl. CPC G06Q 40/12; G06Q 20/3223

(57) ABSTRACT

A method, a computer program product, and a computer system for classifying mobile payments as records are provided. When a payment transaction is made via a mobile device, the mobile device sends a payment receipt, as well as payment time and location, to a remote records management server for automatic declaration and classification. Four record classification schemes, which make search, retention, and disposition more efficient, are disclosed. The four schemes are amount-based, timing-based, location-based, and combination of amount/timing/location.

### TECHNICAL FIELD OF THE INVENTION

The present invention relates generally to a records management system, and more particularly to classifying mobile payments by the records management system.

### BACKGROUND

Today there exists records management software that declares and classifies traditional payment receipts as records to comply with record management requirements for payment information. As Near Field Communication (NFC) and mobile payment technologies (for example, Google Wallet™ in Android devices) emerge, mobile payment shall also be declared as records to comply with the requirements.

Records Management System (RMS), for example IBM® Enterprise Records, provides accurate, secure, and reliable life-cycle management for digital information to comply with the standards of corporations, government, or other organizations. RMS also provides mechanisms for timely retention and disposition of records to support the compliance control policies.

A system of File Plan is used to manage and classify records across repositories of records management server programs. The File Plan system incorporates a category hierarchy which may include a tree structure; the tree structure comprises record containers (such as record categories), record folders, and volumes. The File Plan system defines how records are classified. Classification of the records can be designed based on business needs to make the classification efficient for records retrieval and retention.

### SUMMARY

In one aspect, a method for classifying mobile payments as records is provided. The method includes steps executed by a server: creating a record container based on a classification scheme, wherein the classification scheme is one of: amount-based, timing-based, location-based, and a combination thereof; and storing a payment receipt from a mobile device as a record into the record container.

In another aspect, a computer program product for classifying mobile payments as records is provided. The computer program product comprises a computer readable storage medium having program code embodied therewith. The program code is executable to create, by a server, a record container based on a classification scheme, wherein the classification scheme is one of: amount-based, timing-based, location-based, and a combination thereof. The program code is executable to store, by the server, a payment receipt from a mobile device as a record into the record container.

In yet another aspect, a computer system for classifying mobile payments as records is provided. The computer system comprises one or more processors, one or more computer-readable tangible storage devices, and program instructions stored on at least one of the one or more computer-readable tangible storage devices for execution by at least one of the one or more processors. The program instructions are executable to create, by a server, a record container based on a classification scheme, wherein the classification scheme is one of: amount-based, timing-based, location-based, and a combination thereof. The program instructions are executable to store, by the server, a payment receipt from a mobile device as a record into the record container.

### BRIEF DESCRIPTION OF THE SEVERAL VIEWS OF THE DRAWINGS

FIG. 1 is a diagram illustrating a system comprising mobile devices and a records management system, in accordance with one embodiment of the present invention.

FIG. 2 is a diagram illustrating architecture of classifying mobile payments as records, in accordance with one embodiment of the present invention.

FIG. 3 is a flowchart illustrating operation steps of classifying mobile payments as records, in accordance with one embodiment of the present invention.

FIG. 4 is a diagram illustrating components of a computer device (i.e., a mobile device or a records management server shown in FIG. 1 and FIG. 2), in accordance with one embodiment of the present invention.

### DETAILED DESCRIPTION

Embodiments of the present invention disclose a core idea to declare and classify mobile payments as records. When a payment transaction is made via mobile device, the mobile device sends a payment receipt, as well as the payment time and location, to a remote records management server for automatic declaration and classification. Embodiments of the present invention also disclose four record classification schemes which make search, retention, and disposition more efficient. The four schemes are amount-based, timing-based, location-based, and combination of amount/timing/location.

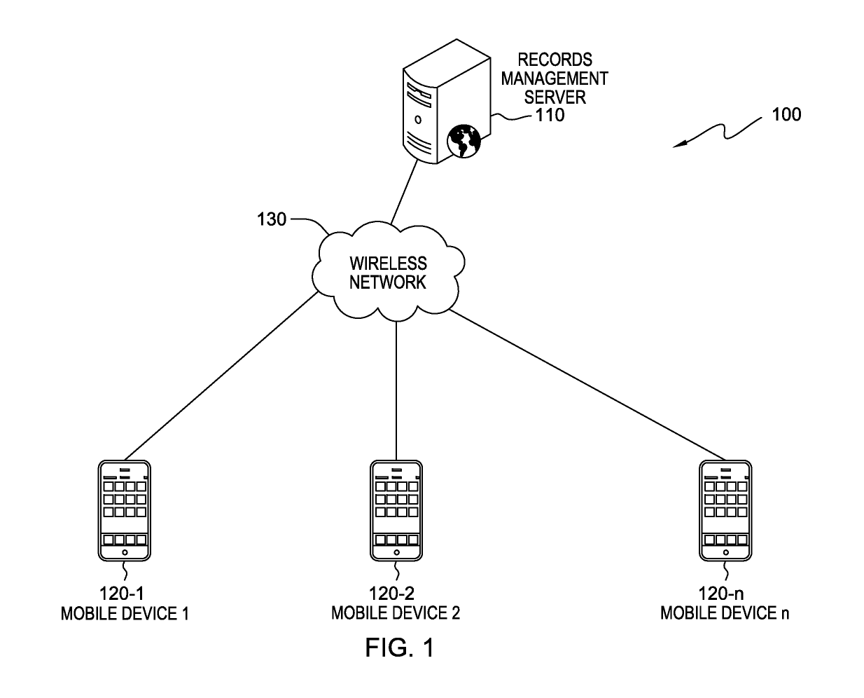

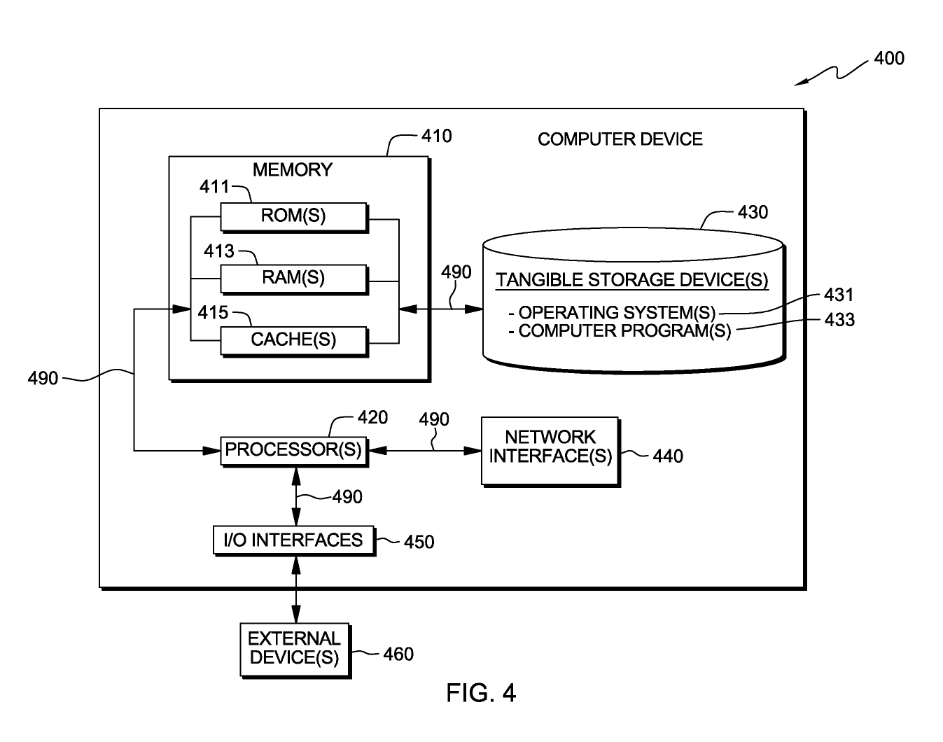

FIG. 1 is a diagram illustrating system 100 which comprises a plurality of mobile devices 1 through n (120-1 through 120-n) and records management server 110, in accordance with one embodiment of the present invention. Mobile devices 1 through n (120-1 through 120-n) are electronic devices or computer systems capable of receiving input from users, executing computer program instructions, and communicating with records management server 110 via wireless network 130. Records management server 110 is on a computer device. Components of the computer device are illustrated in FIG. 4.

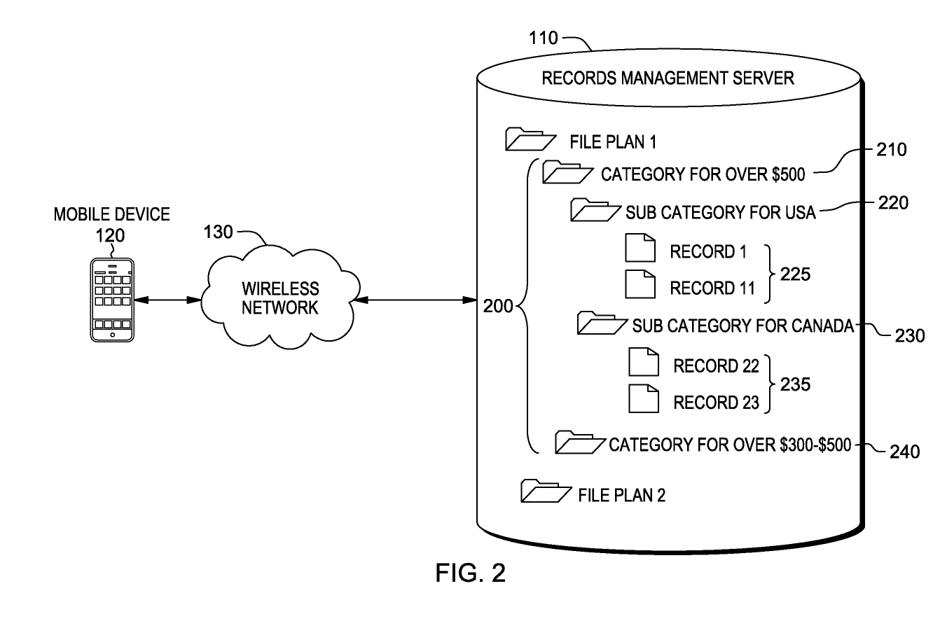

FIG. 2 is a diagram illustrating architecture of classifying mobile payments as records, in accordance with one embodiment of the present invention. When a payment is made via mobile device 120, for example an Android phone making the payment using Google Wallet™, mobile device 120 captures the payment receipt when payment transaction is completed. The mobile device sends, via wireless network 130, the payment receipt, as well as the current geographical location and time, to records management server 110 for declaration and categorization. The declaration and the categorization are processes of Records Management System (RMS). When RMS classifies a document as record, it first declares a document as a record, then categories the record into a record container by different criteria. When records management server 110 receives the payment receipt, location, and date time, records management server 110 generates a record category based on a classification scheme if the record category does not exist, and then stores the payment receipt as a record into the generated record container. If the record category has existed, records management server 110 stores the payment receipt as a record into the existing record container.

Records management server 110 defines classification schemes for the payment receipts. A classification scheme can be amount-based, timing-based, location-based, or a combination thereof. Regarding the amount-based classification scheme, payment records are classified based on the amount. For example, shown in FIG. 2, “category for over $500” (210) and “category for $300-$500” (240) are defined amount-based record containers. It is a common business requirement that different amounts may have different retention periods and different disposition processes. Under this requirement, it makes search and disposition more efficient to categorize payment records into different record containers based on the amount.

Regarding the timing-based classification scheme, payment records are classified based on the date and time of transactions. This is to support timing-based retention and disposition. For example, a specific record must be kept for a certain number of days or years before entering a disposition process. For the timing-based retention and disposition, the timing-based classification makes management of the disposition process more efficient.

Regarding the location-based classification scheme, payments occurring in different locations, such as different states and countries, may need to follow different accounting rules; therefore, the records may require different classification and retention management based on locations. The location-based classification makes this use case more efficient. In examples shown in FIG. 2, “sub-category for USA” (220) and “sub-category for Canada” (230) are location-based record containers.

Based on business requirements, the combination of amount-based, timing-based, and location-based schemes may be necessary. Records management server 110 generates tree-structured categories and sub-categories by amount, timing, or location. Payment receipts can be classified into appropriate categories or sub-categories. FIG. 2 shows an example of a tree-structure (200) including the categories and the sub-categories.

In examples shown in FIG. 2, records management server 110 stores record 1 and record 11 (225) into sub-category for USA (220), which is under category for over $500 (210); records management server 110 stores record 22 and record 23 (235) into sub-category for Canada (230), which is under category for over $500 (210).

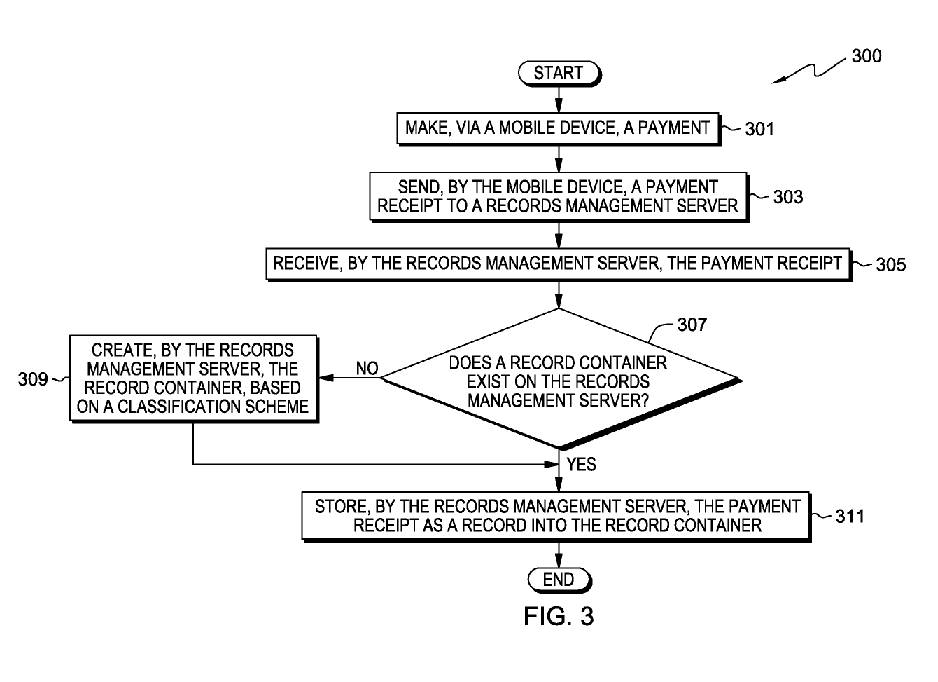

FIG. 3 is flowchart 300 illustrating operation steps of classifying mobile payments as records, in accordance with one embodiment of the present invention. At step 301, a payment is made via mobile device 120 (shown in FIG. 2). When the payment is completed, mobile device 120 captures a payment receipt, as well as the payment time and location. At step 303, mobile device 120 sends the payment receipt, as well as the payment time and location, to records management server 110. Sending the payment receipt, as well as the payment time and location, is via wireless network 130. At step 305, records management server 110 receives the payment receipt, as well as the payment time and location.

Referring to FIG. 3, upon receiving the payment receipt, as well as the payment time and location, at decision block 307, records management server 110 determines whether a record container exists thereon. For example, the payment receipt is to be stored as a record into record container “sub-category for USA” (220 shown in FIG. 2); records management server 110 checks the existence of record container “sub-category for USA” (220 shown in FIG. 2). In response to determining that the record container does not exist (“NO” branch of decision block 307), at step 309, records management server 110 creates the record container based on a classification scheme. The classification scheme can be one of these schemes: amount-based, timing-based, location-based, or a combination thereof. The schemes have been discussed in previous paragraphs in this document. For example, if record container “sub-category for USA” (220 shown in FIG. 2) does not exist, records management server 110 creates this record container. Then, at step 311, records management server 110 stores the payment receipt as a record into the record container. In response to determining that the record container exists (“YES” branch of decision block 307), records management server 110 directly executes step 311.

FIG. 4 is a diagram illustrating components of computer device 400 (i.e., mobile device 120 or records management server 110 shown in FIG. 1 and FIG. 2), in accordance with one embodiment of the present invention. It should be appreciated that FIG. 4 provides only an illustration of one implementation and does not imply any limitations with regard to the environment in which different embodiments may be implemented.

Referring to FIG. 4, computer device 400 includes processor(s) 420, memory 410, tangible storage device(s) 430, network interface(s) 440, and I/O (input/output) interface(s) 450. In FIG. 4, communications among the above-mentioned components of computing device 400 are denoted by numeral 490. Memory 410 includes ROM(s) (Read Only Memory) 411, RAM(s) (Random Access Memory) 413, and cache(s) 415. One or more operating systems 431 and one or more computer programs 433 reside on one or more computer-readable tangible storage device(s) 430. Computing device 400 further includes I/O interface(s) 450. I/O interface(s) 450 allows for input and output of data with external device(s) 460 that may be connected to computing device 400. Computing device 400 further includes network interface(s) 440 for communications between computing device 400 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1-4. (canceled)

5. A computer program product for classifying mobile payments as records, the computer program product comprising a computer readable storage medium having program code embodied therewith, the program code executable to:
create, by a server, a record container based on a classification scheme, wherein the classification scheme is one of: amount-based, timing-based, location-based, and a combination thereof; and
storing, by the server, a payment receipt from a mobile device as a record into the record container.

6. The computer program product of claim 5, further comprising:
in response to making a payment, capture, by the mobile device, the payment receipt; and
send, by the mobile device, the payment receipt to the server.

7. The computer program product of claim 5, wherein the payment receipt includes location and time information of the payment.

8. The computer program product of claim 5, wherein the server receives the payment receipt from the mobile device via a wireless network.

9. A computer system for classifying mobile payments as records, the computer system comprising:
one or more processors, one or more computer-readable tangible storage devices, and program instructions stored on at least one of the one or more computer-readable tangible storage devices for execution by at least one of the one or more processors, the program instructions executable to:
create, by a server, a record container based on a classification scheme, wherein the classification scheme is one of: amount-based, timing-based, location-based, and a combination thereof; and
storing, by the server, a payment receipt from a mobile device as a record into the record container.

10. The computer system of claim 9, further comprising the program instructions executable to:
in response to making a payment, capture, by the mobile device, the payment receipt; and
send, by the mobile device, the payment receipt to the server.

11. The computer system of claim 9, wherein the payment receipt includes location and time information of the payment.

12. The computer system of claim 9, wherein the server receives the payment receipt from the mobile device via a wireless network.
